(19) United States
(12) Patent Application Publication
(10) Pub. No.: US 2009/0043696 A1
(43) Pub. Date: Feb. 12, 2009

(54) Payment Processor Hosted Account Information

(75) Inventors: Matthew R. Ornce, Wilmington, DE (US); Jason J. Gwynn, Newark, DE (US); Raymond Moyer, Landenberg, PA (US); Steve H. Pile, Phoenix, AZ (US); Kent R. Glenn, Avondale, AZ (US); Jason Nowicki, Mesa, AZ (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: ELECTRONIC PAYMENT EXCHANGE, Wilmington, DE (US)

(21) Appl. No.: 12/172,041

(22) Filed: Jul. 11, 2008

Related U.S. Application Data
(60) Provisional application No. 60/963,993, filed on Aug. 8, 2007.

(51) Int. Cl. G06Q 20/00

(52) U.S. Cl. 705/39; 705/35

(57) ABSTRACT

A payment processor may host account information such as an account number of a customer provided during a transaction with a point of sale of a merchant. The account information may be received by the payment processor without being stored at the point of sale. For example, the account information may be received by the payment processor via a web page that may emulate a terminal at the point of sale. The payment processor may store the account information and may establish a unique transaction identifier for the transaction. The unique identifier may be provided to the customer with a receipt and the account number may be provided to an entity that may provide payment the merchant to complete the sales transaction.

### CROSS-REFERENCE TO RELATED APPLICATIONS

This application claims benefit under 35 U.S.C. § 119(e) of U.S. Provisional Patent Application No. 60/963,993, filed on Aug. 8, 2007, the disclosure of which is incorporated herein by reference.

### BACKGROUND

Typically, a point of sale entity such as a retail merchant, a mail order merchant, a telephone order merchant, an electronic commerce merchant, or the like may store account numbers for a customer that initiates a sales transaction therewith. For example, the customer may provide an account number such as a credit card number, a checking account number, or the like to the point of sale entity to pay for goods or services. The point of sale entity may store the credit card number before providing the credit card number to a payment processor. The payment processor may then provide the credit card number to the card network and/or issuer of the credit card to complete the payment for the goods or services received via the point of sale.

Unfortunately, when the point of sale entity stores the account number, the point of sale needs to comply with a set of comprehensive and burdensome requirements for enhancing payment account data security during the receipt, storage, and transmission of account information provided to the point of sale in the sales transaction.

### SUMMARY

Methods and systems are provided that host account information at a payment processor to complete a transaction in such a manner that eliminates any need to store, process, or transmit a customer account number at a point of sale location. According to an example embodiment, the payment processor may receive from the point of sale of a merchant, an account number of a customer in response to the initiation of the transaction at the point of sale. The payment processor may establish a unique transaction identifier corresponding to the transaction that may be associated with the account number. In an example embodiment, the payment processor may store the account number and the unique transaction identifier. The payment processor may also provide the unique transaction identifier to the point of sale and the account number to an entity that provides payment to the merchant from an account associated with the account number of the customer to complete the sales transaction such that the transaction may completed without storing the account number of the customer at the point of sale.

### BRIEF DESCRIPTION OF THE DRAWINGS

FIG. 1 depicts an example of a prior art system used to process a transaction.

FIG. 2 depicts an example embodiment of a payment processor configured to host account information during a sale or authorization transaction at a point of sale of a retail merchant.

FIG. 3 depicts an example embodiment of voiding a transaction at a payment processor configured to host account information for a point of sale of a retail merchant.

FIG. 4 depicts an example embodiment of crediting a transaction at a payment processor configured to host account information for a point of sale of a retail merchant.

FIG. 5 depicts an example embodiment of capturing a transaction at a payment processor configured to host account information for a point of sale of a retail merchant.

FIG. 6 depicts an example embodiment of a cardless payment transaction at a payment processor configured to host account information for a point of sale of a retail merchant.

FIG. 7 depicts an example embodiment of a payment processor configured to host account information during a sale or authorization transaction at a point of sale of a mail order and/or telephone merchant.

FIG. 8 depicts an example embodiment of voiding a transaction at a payment processor configured to host account information for a point of sale of a mail order and/or telephone merchant.

FIG. 9 depicts an example embodiment of crediting a transaction at a payment processor configured to host account information for a point of sale of a mail order and/or telephone merchant.

FIG. 10 depicts an example embodiment of capturing a transaction at a payment processor configured to host account information for a point of sale of a mail order and/or telephone merchant.

FIG. 11 depicts an example embodiment of a cardless payment transaction at a payment processor configured to host account information for a point of sale of a mail order and/or telephone merchant.

FIG. 12 depicts an example embodiment of a payment processor configured to host account information during a sale or authorization transaction at a point of sale of an electronic commerce merchant.

FIG. 13 depicts an example embodiment of voiding a transaction at a payment processor configured to host account information for a point of sale of an electronic commerce merchant.

FIG. 14 depicts an example embodiment of crediting a transaction at a payment processor configured to host account information for a point of sale of an electronic commerce merchant.

FIG. 15 depicts an example embodiment of capturing a transaction at a payment processor configured to host account information for a point of sale of an electronic commerce merchant.

FIG. 16 depicts an example embodiment of a cardless payment transaction at a payment processor configured to host account information for a point of sale of an electronic commerce merchant.

FIGS. 17-19 are screenshots of one embodiment of a processor-hosted interface that emulates a terminal.

FIGS. 20-29 are screenshots of another embodiment of a processor-hosted interface that emulates a terminal.

### DETAILED DESCRIPTION OF ILLUSTRATIVE EMBODIMENTS

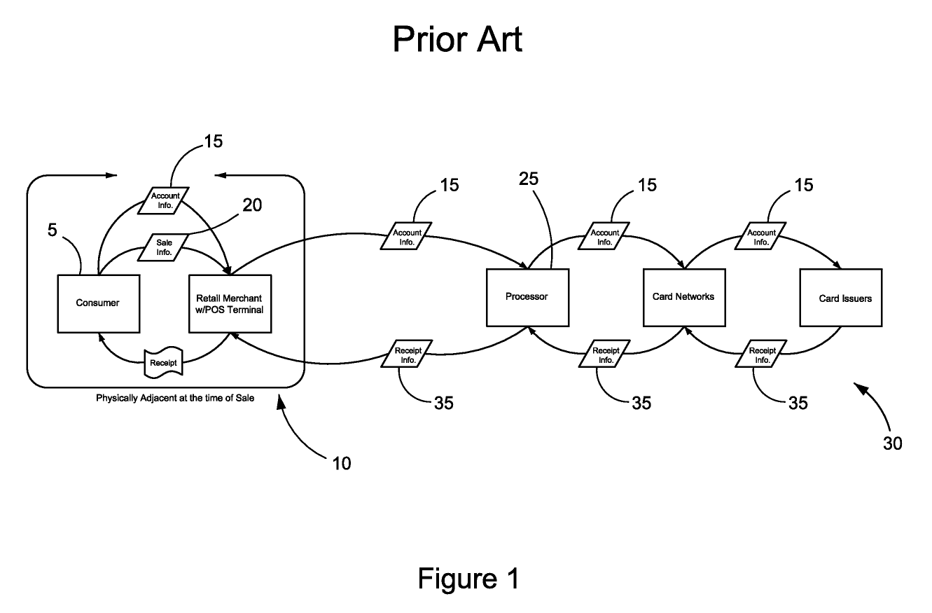

FIG. 1 depicts an example of a prior art system used to process a transaction such as a sales transaction, a credit transaction, an authorization, or the like. As shown in FIG. 1, in a typical transaction such as a sales transaction, a consumer 5 purchases goods, services, or the like at a point of sale 10 of a merchant. The consumer 5 provides account information 15 such as an account number associated with a credit card used to pay for goods, services, or the like and sales information 20 such as the serial number, Stock Keeping Unit (SKU) number, or the like that identifies the goods, services, or the like purchased. The point of sale 10 typically operates a terminal such as a computer, cash register, or the like that receives and stores the account information 15 and sales information 20.

The point of sale 10 provides the account information 15 to a payment processor 25 that arranges for the settlement of the funds from the consumer's account to the merchant for the goods and/or services purchased. The payment processor 25 routes the account information to an issuer 30 to arrange for the settlement of funds to the merchant from an account of the consumer. The issuer 30 typically includes a bank, a credit union, a credit card company, or any other entity that manages the account information 15 and provides payment to the merchant from an account of the customer associated with the account information 15.

After receiving the account information from the payment processor 25, the issuer 30 authorizes payment to the merchant from the account associated with the account information 15 provided by the customer. To acknowledge payment, the issuer 30 typically provides receipt information 35 to payment processor 25. The payment processor 25 then provides the receipt information to the point of sale 10.

In such a prior art system, as described above, the point of sale 10 stores the account information 15 before transmitting such information to payment processor 25. Because the terminal engages in such storage, processing, and transmitting, the point of sale 10 is subject to comply with the Payment Card Industry Data Security Standard (PCI DSS) adopted by the Payment Card Industry Security Standards Council. The PCI DSS includes a set of comprehensive requirements for enhancing payment account data security during the receipt, storage, and transmission of account information provided to the point of sale 10 in a transaction. Because compliance with the PCI DSS is relatively burdensome for a merchant, it would be desirable if transactions could be performed in a manner that would not require such compliance by a merchant. The present invention achieves that result.

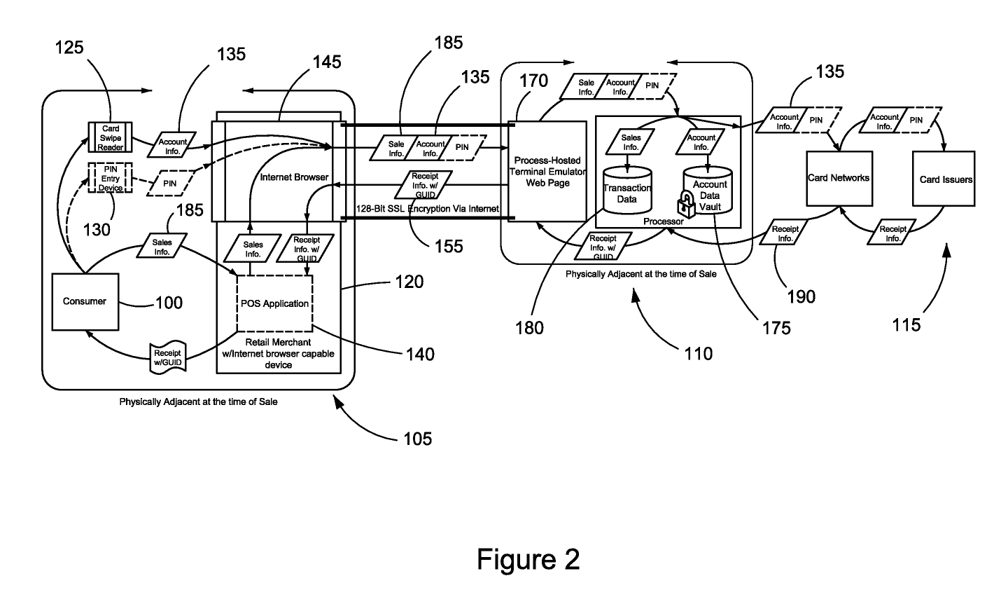

FIG. 2 depicts an example embodiment of a payment processor configured to host account information during a sale or authorization transaction at a point of sale of a retail merchant. As shown in FIG. 2, in an example embodiment, a point of sale 105 of a retail merchant may be in operative communication with a payment processor 110 and a payment entity 115 such that the payment processor 110 may host account information by, for example, storing, processing, and transmitting account information.

The point of sale 105 may include an electronic device 120, an account reader 125, and an entry device 130. The electronic device 120 may be a computer, a terminal, a cash register, or any other suitable electronic device that may be used to provide account information 135 such as an account number to a payment processor 110. According to one embodiment, the electronic device 105 may include a point of sale application 140 and a browser 145. The point of sale application 140 may include a software application that may receive sales information 185 associated with the goods and/or services that may be purchased at the point of sale 105 and/or may generate a receipt corresponding to the sales transaction. The browser 145 may include an internet browser, or the like that may display an emulated terminal provided by the payment processor 110. The browser 145 may receive the account information 135 from a customer 100 during the purchase of goods and/or services and may provide the account information 135 to the payment processor 110 without storing the account information 135 at the point of sale 105.

In an example embodiment, the point of sale 105 may include an account reader 125 that may be connected to the electronic device 120 via a wired connection such as USB, FireWire, Ethernet, or the like or a wireless connection such as Bluetooth, WiFi, Infrared, RF, or the like. The account reader 125 may be a credit card reader, magnetic strip reader, or the like that may read account information stored on, for example, a credit card, debit card, a check, or the like that may be used by the consumer 100 to purchase goods and/or services from the merchant.

The point of sale 105 may also include an entry device 130 that may be connected to the electronic device 120 via a wired connection such as USB, FireWire, Ethernet, or the like and/or a wireless connection such as Bluetooth, WiFi, Infrared, RF, or the like. The entry device 130 may be a touch pad that may receive account information such as an account number, a Personal Identification Number (PIN), or the like that may be entered by the consumer 100 to purchase goods, services, or the like from the merchant. For example, the entry device 130 may be a Personal Identification Number (PIN) entry device that may receive a PIN number from the consumer 100.

The point of sale 105 may be inoperative communication with the payment processor 110 via a network such as the Internet, a Local Area Network (LAN), or a Wide Area Network (WAN), for example. The payment processor 110 may be any entity that handles account information in the flow of transactions between merchants and issuers and/or may assist in the distribution of funds between consumers and merchants, including, for example, entities that may be directly and/or only indirectly involved in the flow of transactions between merchants and issuers and the distribution of funds between consumers and merchants. For example, the payment processor 110 may be a third party service provider that may directly and/or indirectly arrange for the authorization and settlement of funds between the payment entity 115 and the merchant after the purchase of goods, services, or the like.

The payment processor 110 may include any combination of hardware components such as processors, databases, storage drives, registers, cache, RAM memory chips, data buses, or the like and/or software components such as operating systems, database management applications, or the like. According to an example embodiment, the payment processor 110 may include a network-based server that may arrange for the authorization and settlement of the funds between the point of sale 105 and the payment entity 115.

The payment processor 110 may host an interface 170 such as graphical user interface, a web page, or the like that may emulate a terminal at the point of sale 105 in an example embodiment. The interface 170 may be provided to the electronic device 120 via the network such that the browser 145 on the electronic device 120 may display the interface 170 at the point of sale 105.

According to one embodiment, the payment processor 110 may also include an account module 175 and a transaction module 180. The account module 175 may be configured to store the account information 135 such as the account number received from the consumer 100 via the point of sale 105 of the retail merchant. The account module 175 may include, for example, a database, RAM memory chips, cache, registers, hard drives, or any other suitable hardware and/or software components designed to store data such as the account information 135. According to one embodiment, the account information 135 that may be stored in the account module 175 may be indexed by a transaction identifier, which will be described in more detail below.

The transaction module 180 may be configured to establish and store a unique transaction identifier for each sales transaction conducted at the point of sale 105 of the retail merchant, for example. In one embodiment, the transaction identifier comprises a globally unique identifier (GUID). The transaction module 180 may include, for example, a database, RAM memory chips, cache, registers, hard drives, or any other suitable hardware and/or software components designed to establish and store the transaction identifier, which will be described in more detail below.

According to one embodiment, the consumer 100 may purchase goods, services, or the like at the point of sale 105 of a merchant such as a retail merchant. To purchase the goods and/or services, for example, the consumer may provide account information 135 such as an account number associated with an account of the consumer from which payment for the goods and/or services will be made and sales information 185 such as a serial number, Stock Keeping Unit (SKU) number, or the like that may identify the good and/or services being purchased. The account number may be a savings account number, a credit card number, a debit card number, a loan account number, a checking account number or any other number identifying an account from which payment for the goods and/or services is to be made. In one embodiment, the account number is in the form of a Primary Account Number (PAN) of the consumer.

As an example, the consumer 100 may swipe his or her credit card in the account reader 125 connected to the electronic device 120 at the point of sale 105. Additionally, the consumer 100 may enter his or her PIN using the entry device 130 connected to the electronic device 120.

As described above, the electronic device 120 may be in operative communication with the payment processor 110. The payment processor 110 may host the interface 170 that may emulate a terminal at the electronic device 120 of the point of sale 105. The account information 135 may be received by the payment processor 110 via a browser 145 displayed by the electronic device 120.

Additionally, the sales information 185 may be received by the payment processor 110 via the browser 145 displayed by the electronic device 120. For example, the sales information 185 may be received by the point of sale application 140 implemented in the electronic device 120. The point of sale application 140 may store the sales information 185 corresponding to the goods and/or services purchased by the consumer 100. The point of sales application 140 may also provide the sales information 185 to the payment processor 110 via the browser 145 displaying the interface 170.

The payment processor 110 may store the account information 135 including, for example, the account number received via the interface 170 in the account module 175. The payment processor 110 may also store the sales information 185 received via the interface 170 in the transaction module 180.

In one embodiment, the payment processor 110 may establish a unique transaction identifier corresponding to each transaction at the point of sale at the merchant. For example, the payment processor 110 may generate a unique numeric sequence, alphanumeric sequence, or the like that may identify each transaction. Additionally, the transaction identifier may be associated with the account information 135 and the sales information received from the point of sale 105 according to an example embodiment. Thus, in an example embodiment, a transaction may be completed without storing the account information 135, such as the account number, at the point of sale 105 of the merchant.

The payment processor 110 may provide the account information 135 including, for example, the account number to a payment entity 115 that may manage and provide payment to the merchant from an account of the customer 100 associated with the account information 135 received and stored by the payment processor 110. The payment entity 115 may include, for example, a bank, a credit union, a credit card company, or any other suitable entity that may issue, manage, and provide payment from an account of the customer 100 to the merchant. The payment entity 115 may authorize payment to the merchant from the account associated with the account information 135 provided by the customer. To acknowledge such an authorization, the payment entity 115 may provide receipt information 190 such as an authorization code, an authorization approval, or the like to the payment processor 110. The payment processor 110 may receive the receipt information 190. In one embodiment, the payment processor 110 may provide the receipt information 190 to the point of sale 105.

The payment processor 110 may also provide the transaction identifier to the point of sale 105. The payment processor 110 may generate transaction receipt information 155 that may include the sales information such as the SKU, serial number, a description of the goods and/or services, the transaction identifier, and/or the receipt information. The point of sale 105 may then generate a receipt using the transaction receipt information 155 including the transaction identifier to the customer 100 to indicate that the transaction has been completed.

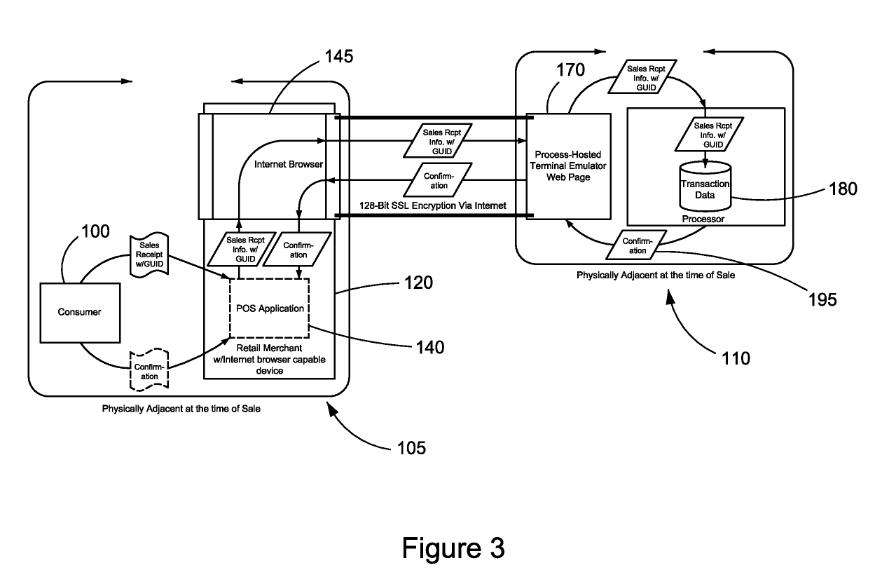

FIG. 3 depicts an example embodiment of voiding a transaction at a payment processor configured to host account information. For example, the consumer 100 may return the good and/or services purchased during the sales transaction. If funds have not been transferred from the payment entity 115 to the merchant, the sales transaction may be voided and/or cancelled such that the funds will not be transferred from the payment entity 115 to the merchant. For example, the customer 100 may purchase a television from a first retail merchant. The customer 100 may find the same television at a second retail merchant, for example. The customer 100 may return the television to the first retail merchant before the funds have been transferred from the payment entity 115 such as the bank, credit union, credit card company, or the like to the first merchant. The transaction may be voided such that the funds for the purchase of the television will not be transferred from the payment entity 115 to the first merchant.

To void a transaction, the customer 100 may provide the transaction identifier to the point of sale when he or she returns the goods and/or services. As described above, the transaction identifier may be a unique identifier associated with each transaction completed at the point of sale 105. The transaction identifier may be received by the point of sale 105 via the browser 145 displaying the interface 170. The point of sale 105 may provide the transaction identifier to the payment processor 110.

The payment processor 110 may receive the transaction identifier from the point of sale 105 in connection with a request by the customer 100 to void the transaction. For example, the payment processor 110 may receive the transaction identifier from the point of sale 105 via the interface 170 hosted at the payment processor 110 and displayed via the browser 145 on the electronic device 120 at the point of sale 105 of the retail merchant.

The payment processor 110 may use the transaction identifier to void the transaction. For example, the payment processor 110 may compare the transaction identifier to an index of transaction identifiers in the transaction module 180 hosted at the payment processor 110.

If the received transaction identifier matches one of the transaction identifiers in the transaction module 180, the transaction module 180 may remove the transaction identifier in the transaction module 180 to void the transaction. Alternatively, if the received transaction identifier matches one of the transaction identifiers in the transaction module 180, the transaction module 180 may communicate with the account module 175 such that the account number may be pulled and the transaction may be voided. For example, the payment processor 110 may provide a request canceling the funds transfer to the payment entity 115 that may provide payment to the merchant from account associated with the account number of the consumer 100. Thus, in one embodiment, the payment processor 110 may void or cancel the transaction before the funds are transferred from the payment entity 115 to the merchant.

After voiding the transaction, the payment processor 110 may provide a confirmation 195 to the point-of-sale indicative of the sales transaction being voided. The confirmation 195 may also be provided to the customer 100 by the point of sale 105 of the retail merchant.

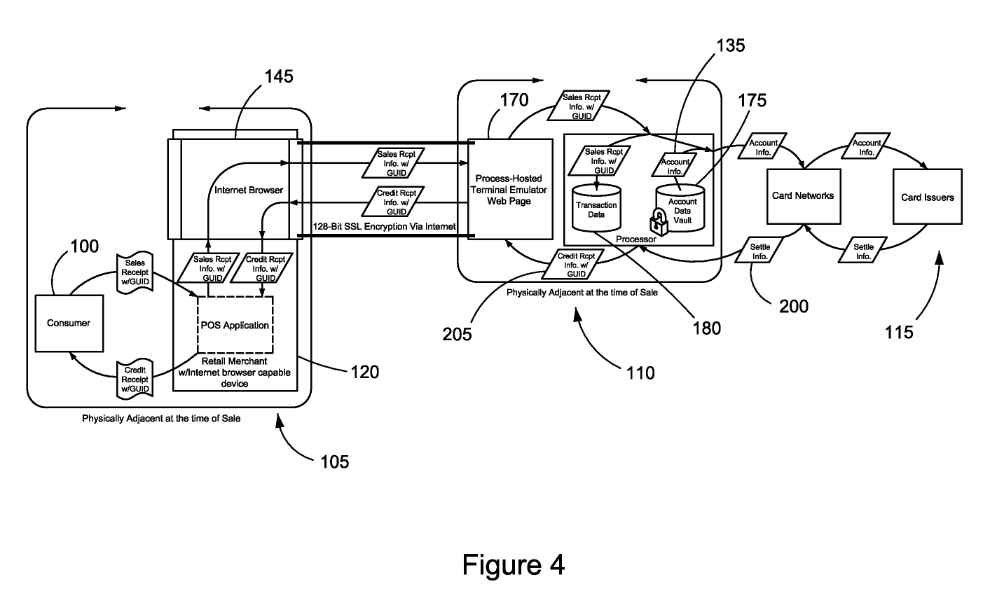

FIG. 4 depicts an example embodiment of crediting a transaction at a payment processor configured to host account information. For example, the consumer 100 may return the good and/or services purchased during the transaction. If funds have been transferred from the customer 100 via the payment entity 115 to the merchant, the transaction may need to be credited such that the funds may be transferred back to the customer via the payment entity 115 from the merchant.

To receive a credit for a transaction, the customer 100 may provide the transaction identifier to the point of sale 105 when he or she returns the goods and/or services. As described above, the transaction identifier may be a unique identifier associated with each transaction completed at the point of sale 105. The transaction identifier may be received by the point of sale 105 via the browser 145 displaying the interface 170. The point of sale 105 may provide the transaction identifier to the payment processor 110.

The payment processor 110 may receive the transaction identifier from the point of sale 105 in connection with a request by the customer 100 to receive a credit for the transaction. For example, the payment processor 110 may receive the transaction identifier from the point of sale 105 via the interface 170 hosted at the payment processor 110 and displayed via the browser 145 on the electronic device 120 at the point of sale 105 of the retail merchant.

The payment processor 110 may use the transaction identifier to credit the transaction. For example, the payment processor 110 may compare the transaction identifier to the index of the transaction identifiers in the transaction module 180 hosted at the payment processor 110. As described above, the payment processor 110 may include a transaction module 180 that may communicate with an account module 175 that may store the account number of the customer 100 used during the transaction. The account module 175 may use the transaction identifier that may be stored in the transaction module 180 to index the account numbers such that when the payment processor 110 receives the transaction identifier during a credit transaction, the payment processor 110 may compare the received transaction identifier with the transaction identifiers that may be stored in the transaction module 180 to determine the account number that may be stored in the account module 175. Alternatively, the account module 175 may index the account number by the transaction identifier such that when the payment processor 110 receives the transaction identifier, the payment processor 110 may compare the received transaction identifier with the transaction identifiers in the account module 175 that may index the account number stored therein.

If the received transaction identifier matches one of the transaction identifiers in the account module 175 and/or transaction module 180, the payment processor 110 may provide the account number and/or other suitable information to the payment entity 115 to complete a credit for the transaction. For example, the payment processor 110 may provide the account number to the payment entity 115 to indicate the account number that the funds are being transferred back to from the merchant. According to one embodiment, the payment processor 110 may queue the request to complete a credit for the transaction such that the payment entity 115 may receive the account number after the payment processor executes the queue.

The payment processor 110 may provide a credit receipt 205 that may include the transaction identifier to the point of sale 105. The credit receipt 205 may indicate that the request has been processed for the transaction corresponding to the transaction identifier. In an example embodiment, the point of sale 105 of the merchant may provide the credit receipt 205 to the consumer 100.

The payment entity 115 may receive the account number from the payment processor 110 after the payment processor 110 executes the queue of requests to credit the funds back to the consumer. The payment entity 115 may then transfer the funds. In one embodiment, the payment entity 115 may provide credit receipt information 200 to the payment processor 110 to indicate the funds have been transferred back to the consumer 100. For example, the credit receipt information 200 may include the account number receiving the credit, or any other suitable information that indicates to the payment processor 110 the funds have been transferred back to the consumer 100.

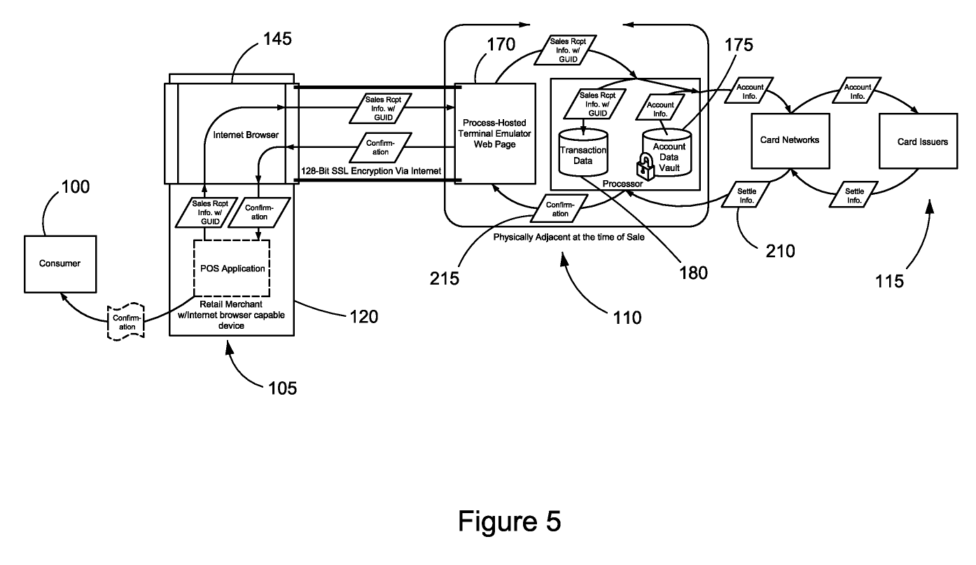

FIG. 5 depicts an example embodiment of capturing a transaction at a payment processor configured to host account information. For example, the consumer 100 may purchase goods and/or services, but funds may not be transferred until the good and/or services purchased are shipped to the consumer 100. Thus, in one embodiment, the transaction may be authorized, but the funds may not be captured or transferred until the goods and/or services may be shipped to the consumer 100.

To authorize the transaction, the consumer 100 may provide the account information 135 to the point of sale 105. The account information 135 may be received by the payment processor 110 via the interface 170 displayed by the browser 145 of the electronic device 120. The sales information 185 may also be received by the payment processor 110 via the interface 170 displayed by the browser 145 of the electronic device 120.

The payment processor 110 may store the account information 135 including, for example, the account number received via the interface 170 in the account module 175. The payment processor 110 may also store the sales information 185 received via he interface 170 in the transaction module 180.

As described above, the payment processor 110 may establish a unique transaction identifier corresponding to each transaction at the point of sale 105 of the merchant. The transaction identifier may be associated with the account information 135 and the sales information 135 received from the point of sale 105 according to an example embodiment.

The payment processor 110 may provide the transaction identifier to the point of sale 105. The point of sale 105 may generate a receipt that may include the sales information such as the SKU, serial number, a description of the goods and/or services, the transaction identifier, and/or the receipt information. The point of sale 105 may then provide the receipt including the transaction identifier to the customer 100 to indicate that the transaction has been completed.

To capture the transaction, once the goods and/or services have been shipped, for example, the point of sale 105 may provide the transaction identifier to the payment processor 110. The payment processor 110 may provide the account information 135 including, for example, the account number to the payment entity 115. The payment entity 115 may authorize payment to the merchant from the account associated with the account information 135 provided by the consumer 100. To acknowledge such a payment, the payment entity 115 may provide receipt information 210 such as an authorization code, an authorization approval, the transaction identifier, or the like to the payment processor 110. The payment processor 110 may receive the receipt information 210. In one embodiment, the payment processor 110 may provide the receipt information 210 to the point of sale 105 to acknowledge that the payment entity 115 received the information for a funds transfer, for example.

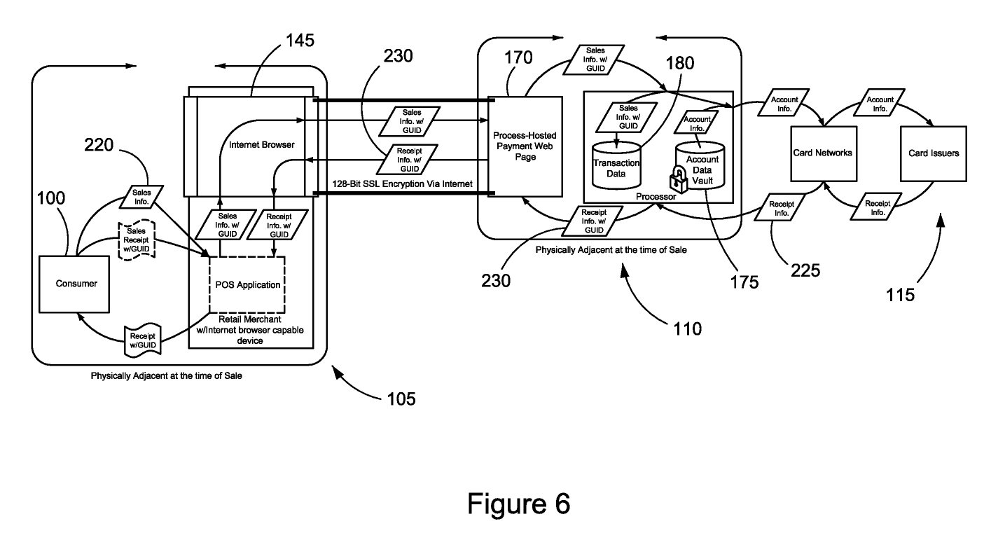

FIG. 6 depicts an example embodiment of a cardless payment transaction at a payment processor configured to host account information. For example, the consumer 100 may purchase goods and/or services from the point of sale 105 of the retail merchant as described above in FIG. 2. The consumer 100 may receive a receipt with the transaction identifier for the first transaction. The consumer 100 may return to the point of sale 105 of the retail merchant to purchase additional goods and/or services in a second transaction. To pay for goods and/or services of the second transaction, the consumer 100 may provide the receipt including the transaction identifier of the first transaction to the point of sale 105 of the retail merchant.

The point of sale 105 of the retail merchant may provide the transaction identifier of the first transaction and the new sales information 220 for the good and/or services purchased in the second transaction to the payment processor.

The payment processor 110 may receive the new sales information 220 and the transaction identifier of the first sales transaction from the point of sale 105. For example, as described above, the payment processor 110 may receive the new sales information 220 and the transaction identifier of the first transaction via the interface 170 hosted by the payment processor 110 and displayed via the browser 170 of the electronic device 120. The payment processor 110 may establish a unique transaction identifier for the second transaction.

Additionally, the payment processor 110 may determine the account information 135 including account number associated with the transaction identifier of the first transaction. For example, the payment processor 110 may compare the transaction identifier of the first transaction to the index of the transaction identifiers in the transaction module 180 of the payment processor 110. The transaction module 180 may then communicate with the account module 175 to determine the account number corresponding to the transaction identifier.

Alternatively, the account module 175 may index the account number by the transaction identifier of the first transaction such that when the payment processor 110 receives the transaction identifier of the first transaction during the second transaction, the payment processor 110 may compare the received transaction identifier of the first transaction with the transaction identifiers that may index the account numbers stored in the account module 175.

If the received transaction identifier of the first transaction matches one of the transaction identifiers in the account module 175 and/or the transaction module 180, the payment entity 110 may provide the account number to the payment entity 115 to pay for the goods and/or services being purchased in the second transaction.

The payment entity 115 may authorize payment to the merchant from the account associated with the account information 135 corresponding to the first transaction. To acknowledge such an authorization, the payment entity 115 may provide receipt information 225 such as an authorization code, an authorization approval, or the like to the payment processor 110. The payment processor 110 may receive the receipt information 225. In one embodiment, the payment processor 110 may provide the receipt information 225 to the point of sale 105.

The payment processor 110 may also provide the transaction identifier for the second transaction to the point of sale 105. The point of sale 105 may generate transaction receipt information 230 that may include the sales information such as the SKU, serial number, a description of the goods and/or services, the transaction identifier, and/or the receipt information. The point of sale 105 may then generate a receipt using the transaction receipt information 230 including the transaction identifier for the second transaction to the consumer 100 to indicate that the second transaction has been completed.

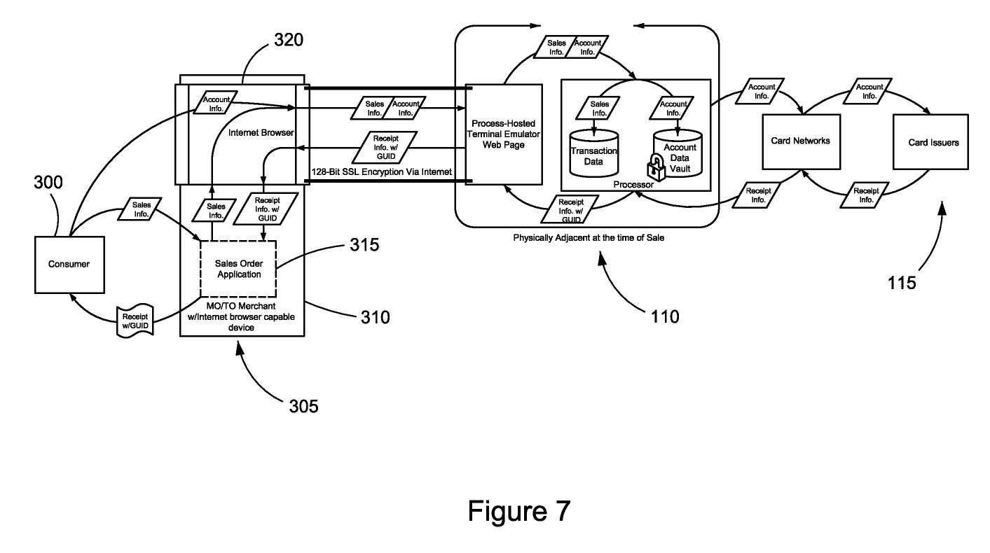

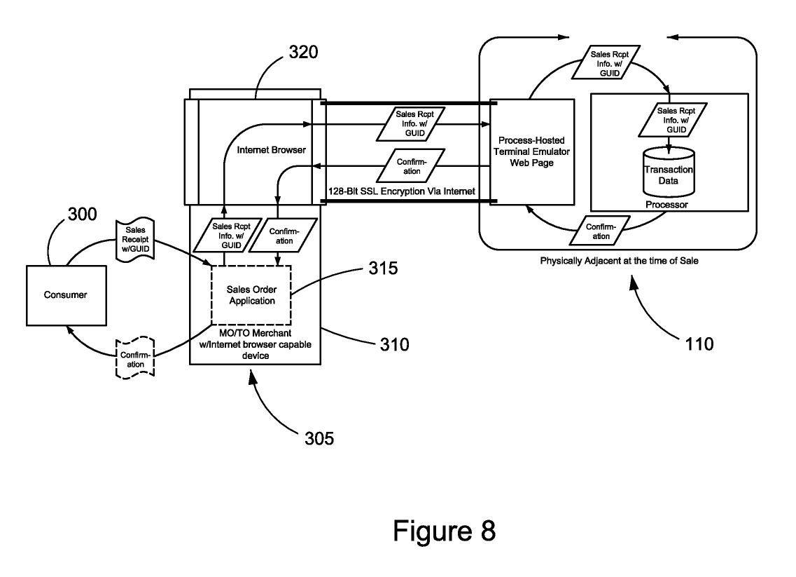

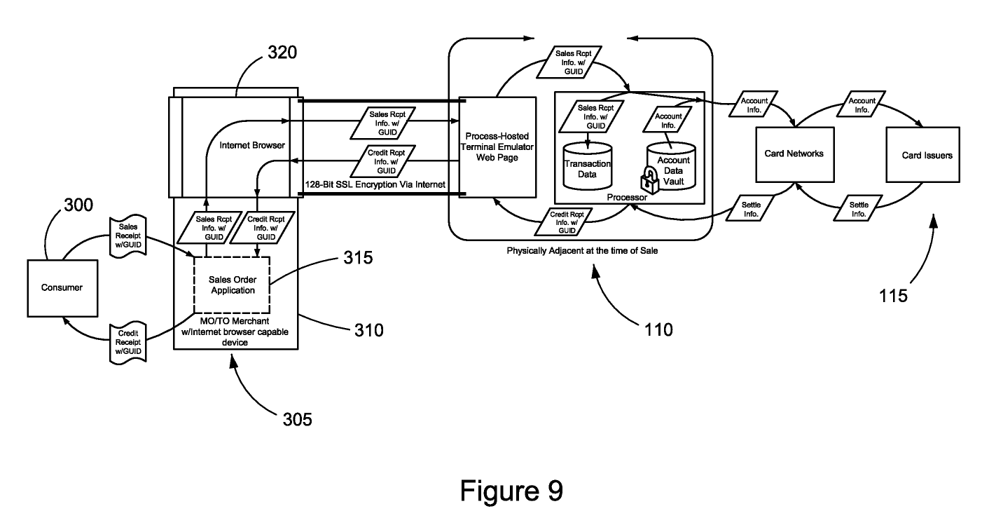

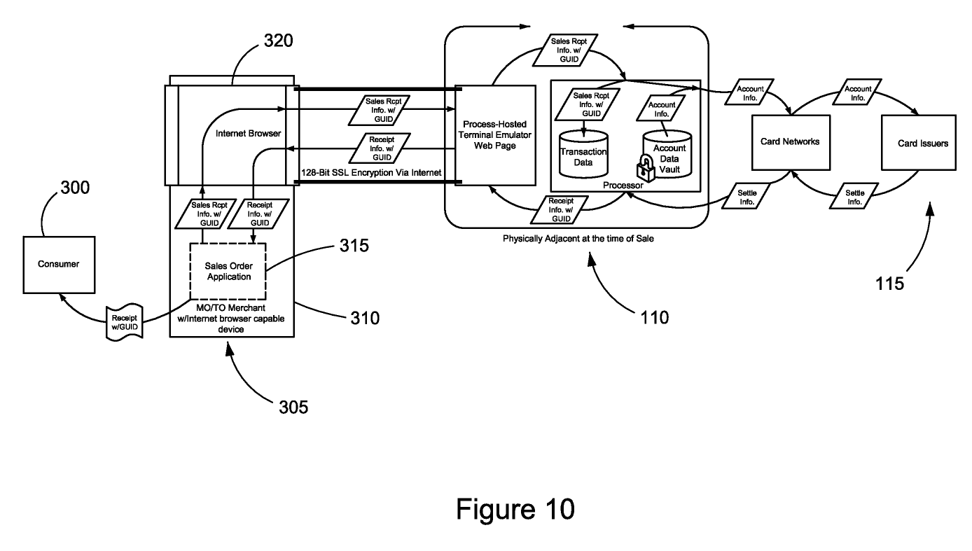

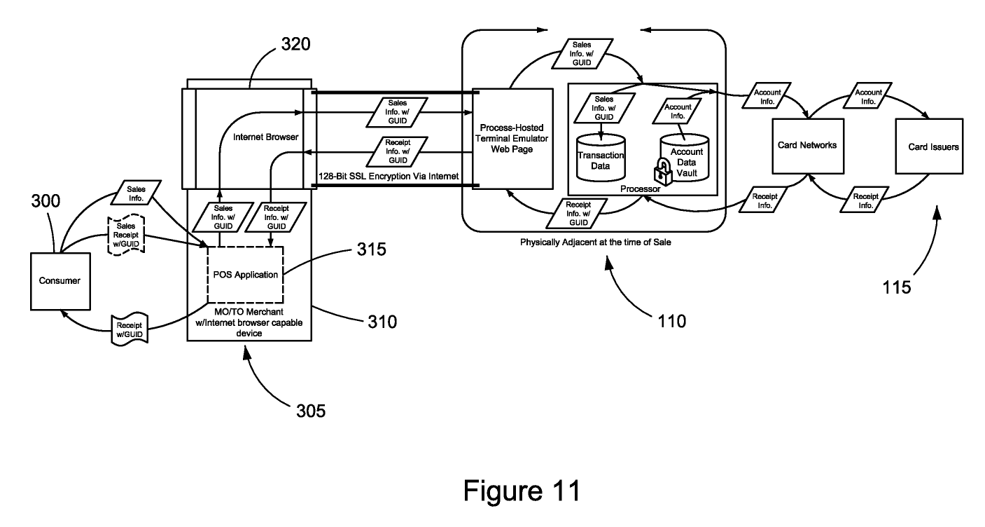

FIGS. 7-11 depict an example embodiment of a payment processor configured to host account information during a transaction at a mail order and/or telephone order merchant. As shown in FIGS. 7-11, in an example embodiment, a point of sale 305 of the mail order and/or telephone order merchant may be in operative communication with the payment processor 110 and the payment entity 115.

The point of sale 305 may include an electronic device 310. The electronic device 310 may be computer, a terminal, a cash register, or any other suitable electronic device that may be used to provide account information such as an account number to the payment processor 110. According to one embodiment, the electronic device 310 may include a sales order application 315 and a browser 320. The sales application 315 may include a software application that may receive sales information associated with the goods and/or services that may be purchased at the point of sale and/or generates receipt information corresponding to the sales transaction. The browser 320 may include an internet browser, or the like that may display the interface 170 hosted by the payment processor 110 that may emulate a terminal at the point of sale 305. The browser 320 may receive the account information provided by a consumer 300 during the purchase of goods and/or services and may provide the account information to the payment processor 110 without storing the account information at the point of sale 305. For example, the sales associate that may receive the mail order and/or the telephone order at the point of sale 305 may enter the account information provided by the consumer 300 into the interface 170 displayed by the browser 320 on the electronic device 310. The account information may be received by the payment processor 110 without being stored by, for example, the electronic device 310 at the point of sale 305.

As shown in FIGS. 7-11, the flow of account information, sales information, credit information, receipt information, and the transaction identifier, for example, of a sales transaction, void transaction, credit transaction, capture transaction, and/or cardless transaction between the point of sale of the mail order and/or telephone order merchant, the payment processor, and the payment entity may otherwise be similar to the flow described above in FIGS. 2-6. For example, the payment processor 110 may receive the account information including the account number via the browser that may display the interface 170 that emulates a terminal at the point of sale to the sales associate processing the order.

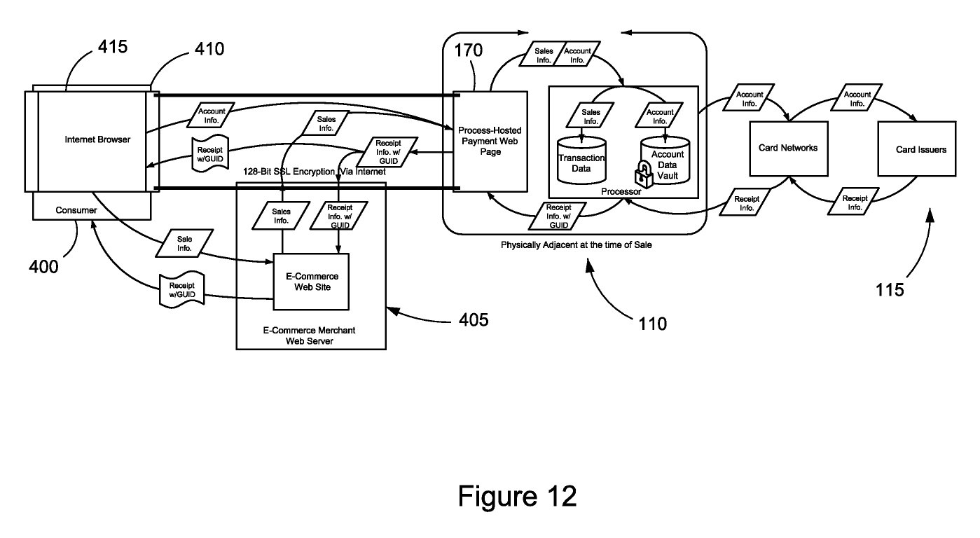

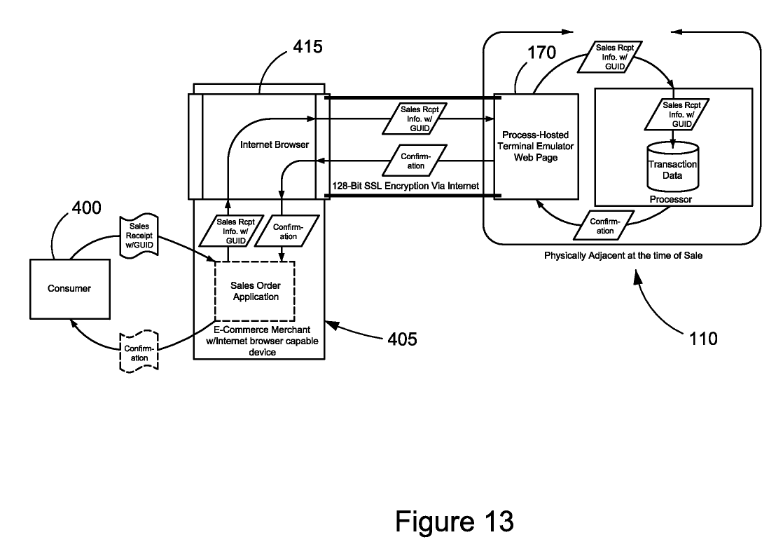

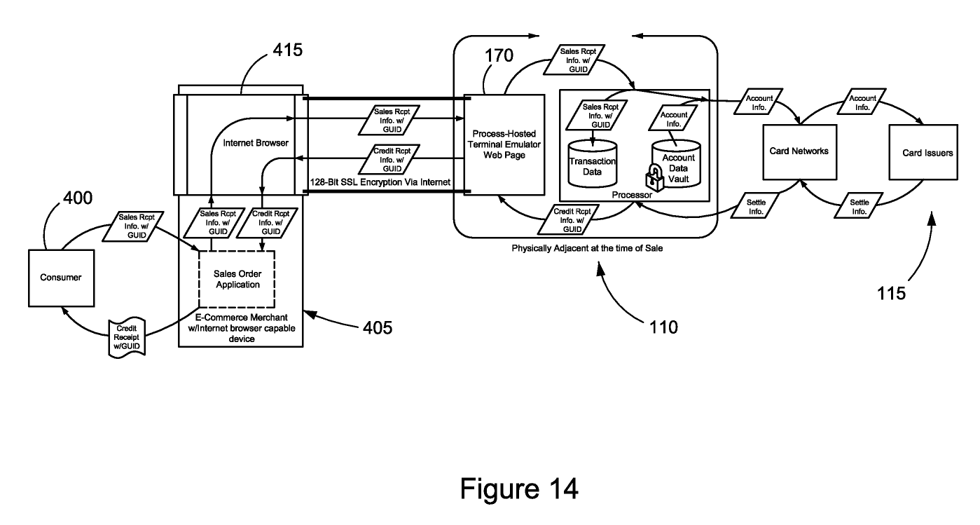

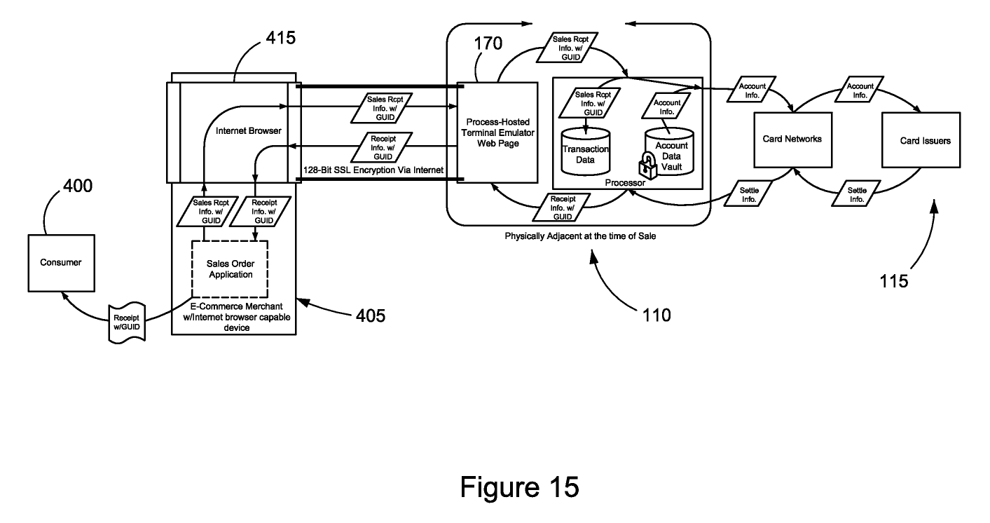

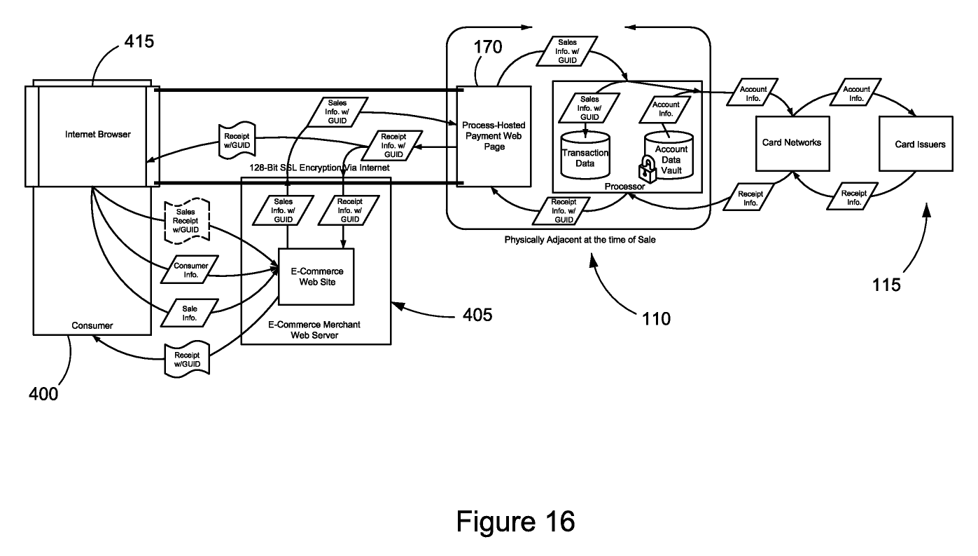

FIGS. 12-16 depict an example embodiment of a payment processor configured to host account information during a transaction at an electronic commerce merchant. As shown in FIGS. 12-16, in an example embodiment, an electronic device 410 that may be operated by the consumer 400 and an electronic commerce merchant server 415 may be in operative communication with the payment processor 110 and the payment entity 115 via the payment processor 110.

The electronic device 410 may be a computer, a wireless device such as a Personal Data Assistant (PDA), or any other suitable electronic device that may be used by the consumer 400 to purchase goods and/or services online. The electronic device 410 may include a browser 415. The browser 415 may include an internet browser, or the like that may display the interface 170 hosted by the payment processor 110 that may emulate a terminal at the electronic device 410 of the consumer 400. The browser 415 may receive account information entered by the consumer 400 during the online purchase of goods and/or services and may provide the account information to the payment processor 110 without storing, processor, or transmitting the account information at the electronic device 410 or the electronic commerce merchant server 415. For example, the consumer 400 may enter the account information into the interface 170 displayed by the browser 415 on the electronic device 410. The account information may be received by the payment processor 110 without being stored by, for example, the electronic device 410 or the electronic commerce merchant server 415.

The electronic device 410 may be in operative communication with the electronic commerce merchant server 415 such that the sales information that may identify the goods and/or services purchased by the consumer may be provided to the electronic commerce merchant server 415. The electronic commerce server 415 may provide the sales information to the interface 170 hosted by the payment processor 110.

As shown in FIGS. 12-16, the flow of account information, sales information, credit information, receipt information, and the transaction identifier, for example, of a sales transaction, void transaction, credit transaction, capture transaction, and/or cardless transaction between the electronic device, the electronic commerce merchant server, the payment processor, and the payment entity may otherwise be similar to the flow described above in FIGS. 2-6 and 8-11. For example, the payment processor 110 may receive the account information including the account number via the browser that may display the interface 170 that emulates a terminal at the electronic device and the point of sale.

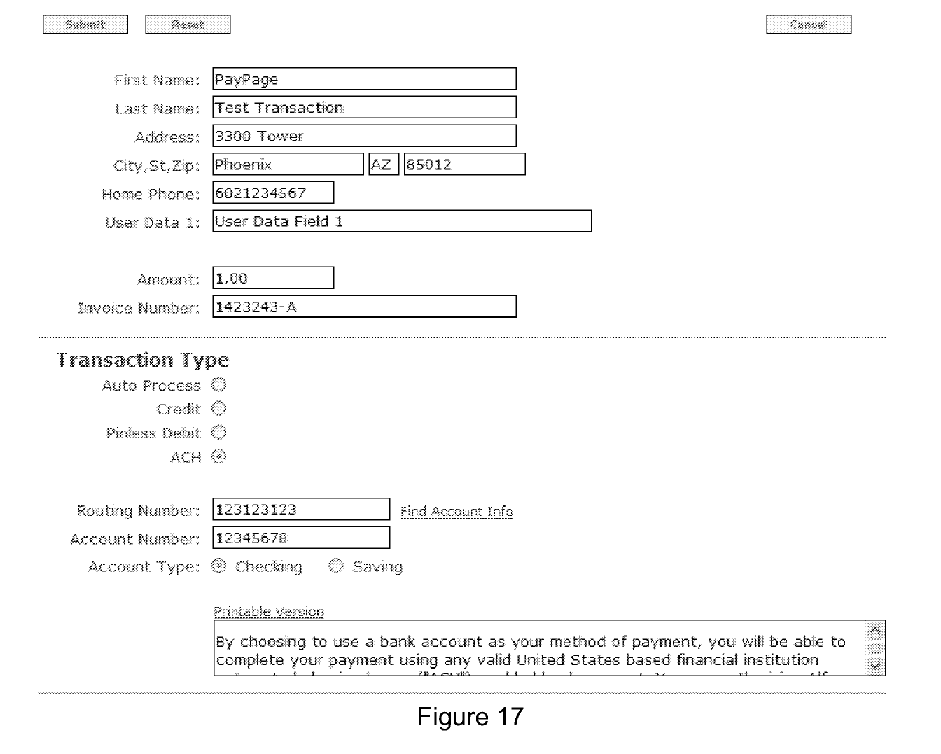

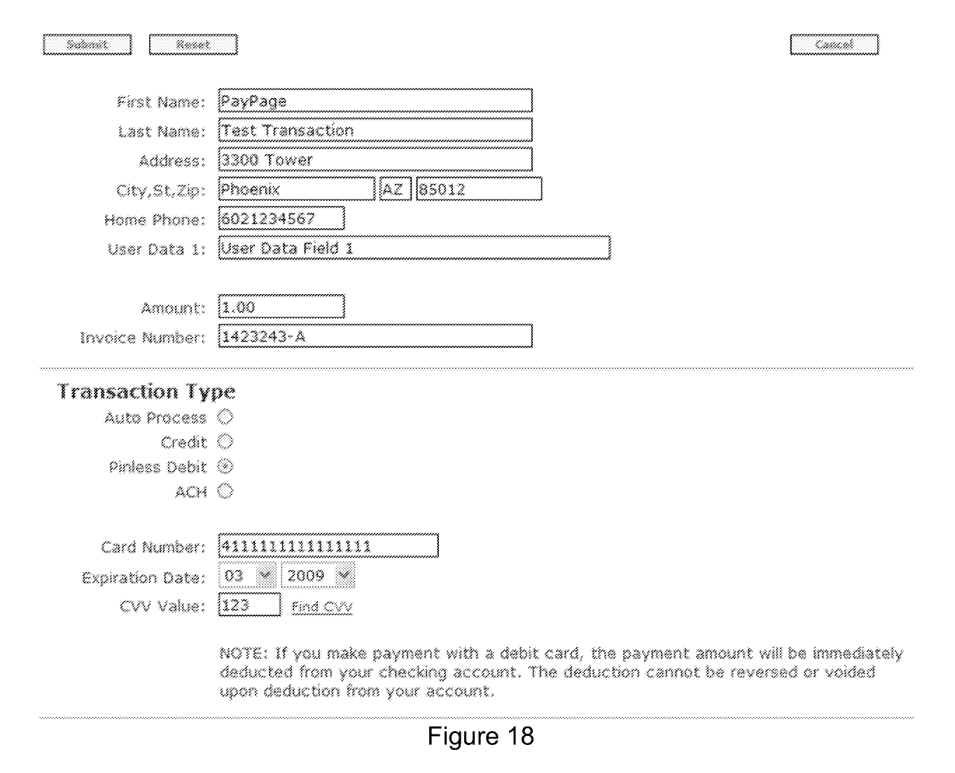

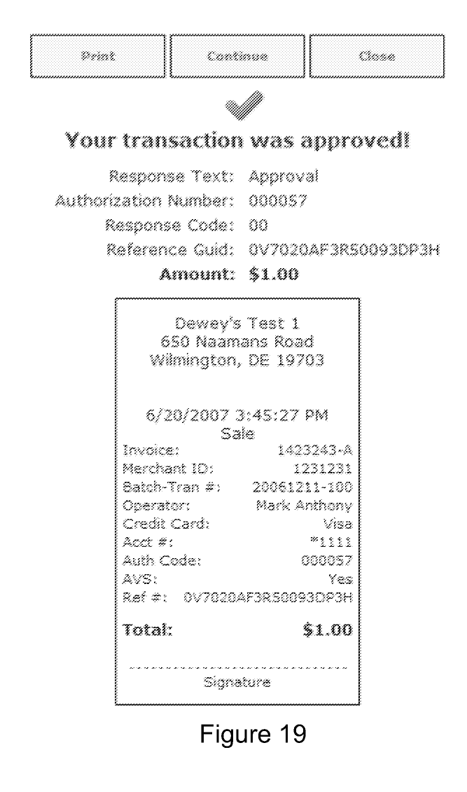

FIGS. 17 and 18 are screen shots of one example embodiment of the interface 170 hosted by the payment processor. FIG. 17 illustrates the data entry fields of the interface 170 as presented at the point of sale 105 when performing an ACH transaction. FIG. 18 illustrates the data entry fields of the interface as presented at the point of sale 105 when performing a pin-less debit transaction. FIG. 19 shows an example of a sales receipt presented to the point of sale by the processor-hosted interface after the transaction is completed. As shown, the “Reference Guid” constitutes an example of a transaction identifier established by the payment processor as described above.

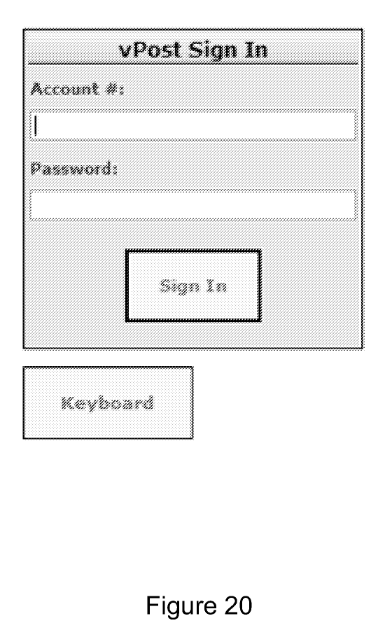

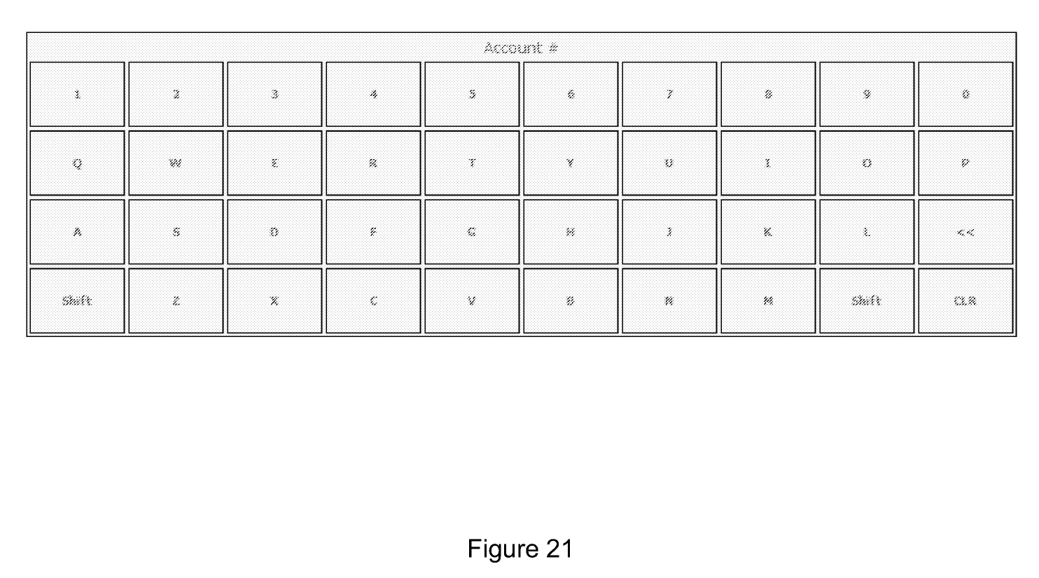

FIGS. 20-29 are screen shots of another example embodiment of the interface 170. A user may sign-in to the processor-hosted interface 170 using the sign-in screen illustrated in FIG. 20. In this embodiment, clicking the “keyboard” button opens up a QWERTY-style keyboard as shown in FIG. 21. The top of the keyboard reflects which field the operator is entering data into, in this example “Account #”. In other embodiments, sign-in may be automated using, for example, an encrypted Message Authorization Code (MAC).

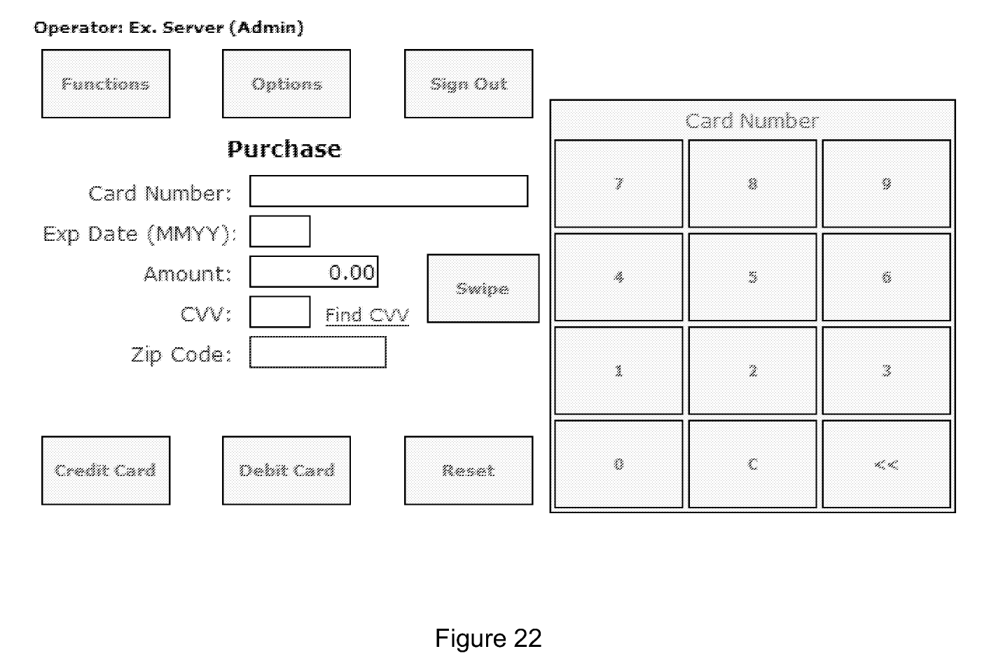

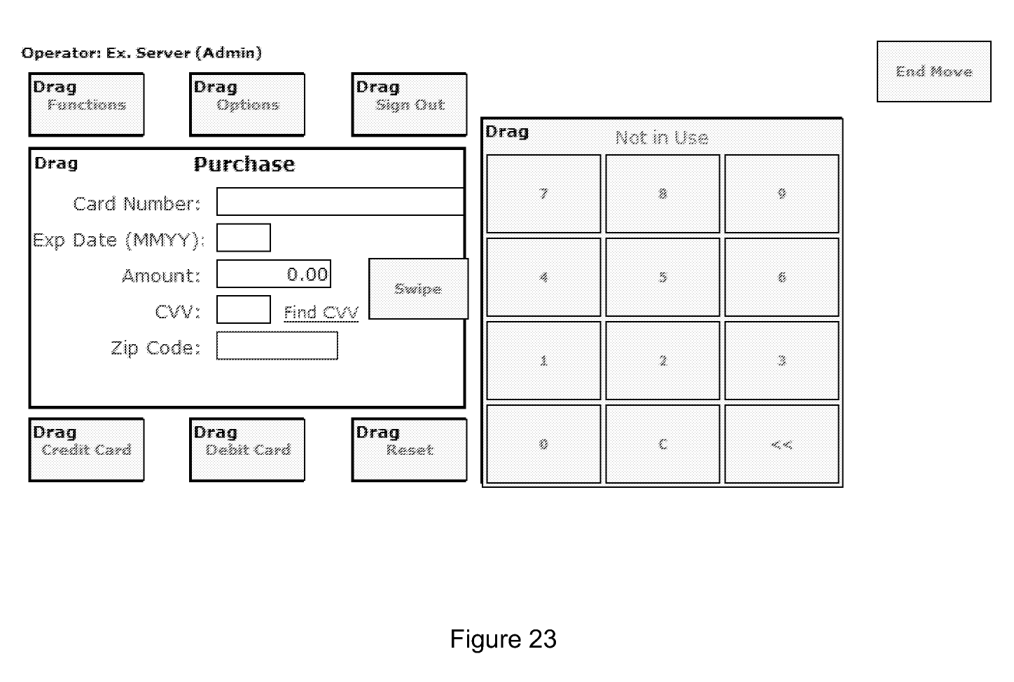

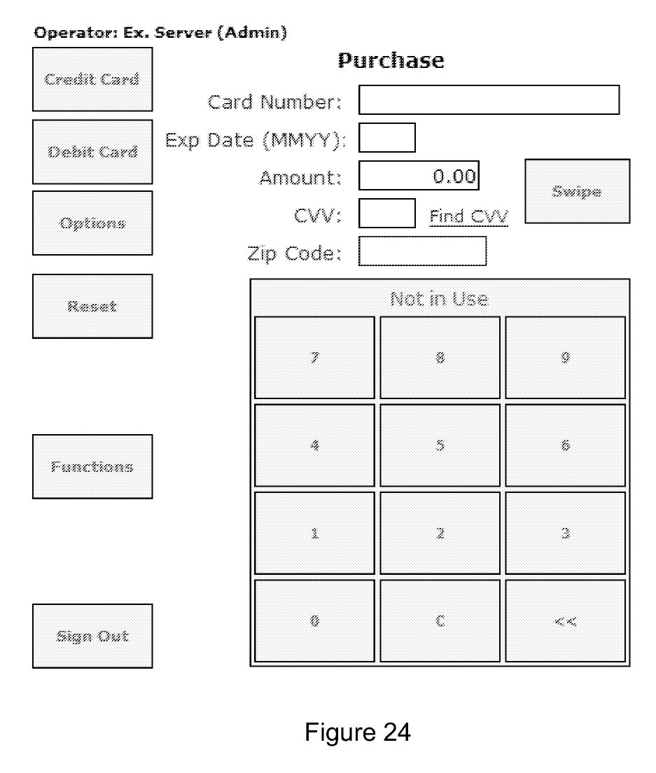

FIG. 22 shows the default configuration of the interface, as displayed after successful sign-in. The default layout has two rows of buttons surrounding various entry fields, and a numeric keypad to the right. In one embodiment, one of the “Functions” that is available to the user is a “Move Objects” function that allows the default layout to be rearranged. As shown in FIG. 23, when the “Move Objects” function is selected, the screen provides the ability for the user to “drag” the items on the screen into new locations. Clicking the “End Move” button in the upper right of the screen completes the operation. FIG. 24 shows a screen shot of one example of a rearrangement of the elements of the screen.

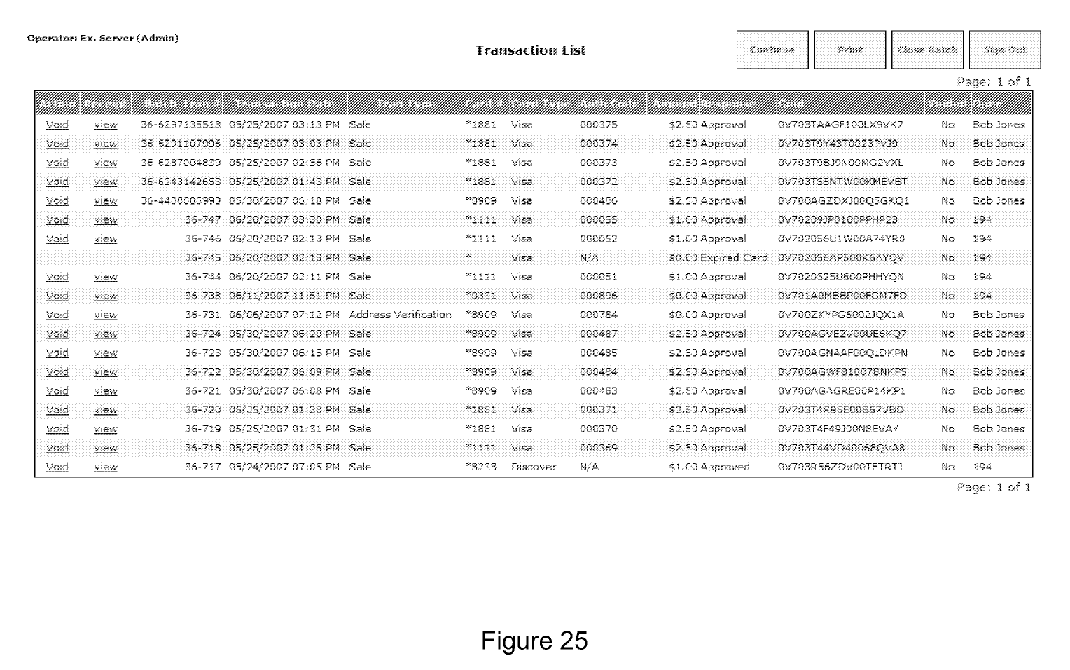

FIG. 25 illustrates a “Transaction List” screen that a user may request from a list of choices presented after clicking the “Options” button on the main screen (FIG. 22 or 24). From the Transaction List screen, an operator may Void a transaction, view a receipt for a previous transaction, print the list of transactions, and/or close the batch to, for example, signify the end of the current payment processing cycle and move the transactions to a state where funds may be released by the consumer to the merchant.

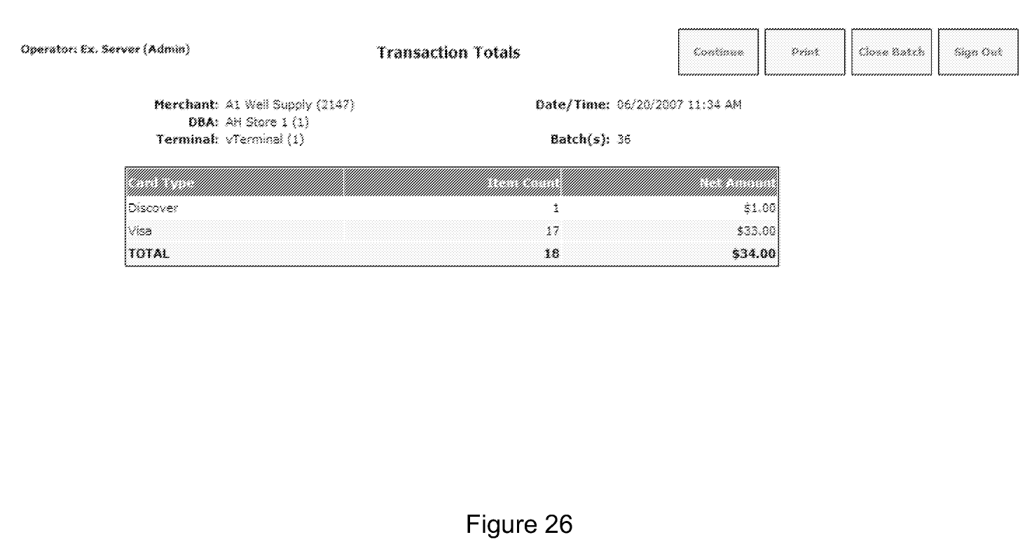

FIG. 26 illustrates a “Transaction Totals” screen that a user may request via the “Options” button on the main screen. This screen displays a summary of approved, current transaction information by card type. A user may print the transaction summary or close the batch, as described above.

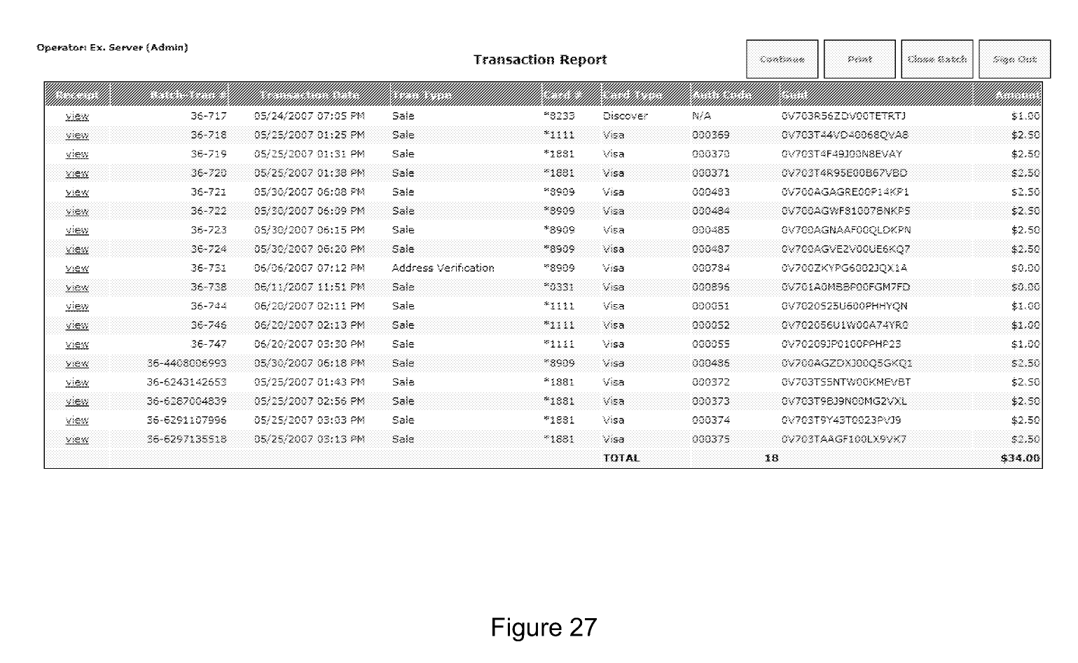

FIG. 27 illustrates a “Transaction Report” screen that a user may also request via the “Options” button on the main screen. This screen displays current transaction information. An operator may view a receipt for a previous transaction, print the list of transactions or close the batch.

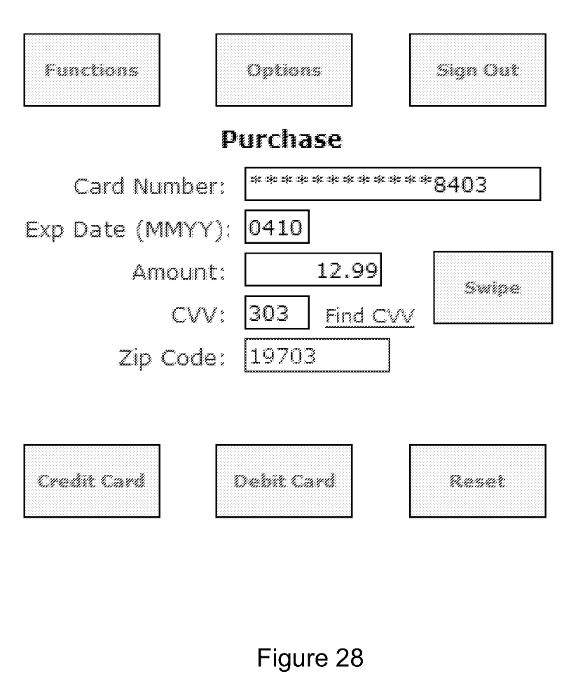

With reference to FIG. 28, data such as a credit card number and sale information can be entered manually using the main screen. Alternatively, the credit card information can be entered via a card swipe. To do so, the “Swipe” button is pushed, and the user swipes the card. The card number and expiration date will populate automatically. The “Amount,” “CW” and “Zip Code” are still entered manually. After the credit card and sale information has been entered, a payment type (e.g., Credit Card or Debit Card) is selected and the transaction is then submitted the payment processor 110. The payment processor 110 may provide such information to the payment entity 115 for authorization.

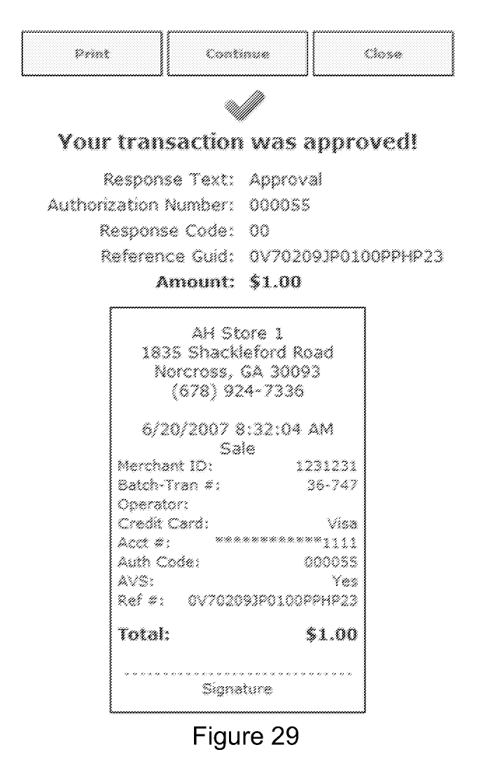

With reference to FIG. 29, after the transaction has been submitted and a response is received, a “Receipt Window” may be displayed. Like the embodiment of FIGS. 17-19, the receipt includes the transaction identifier (“Reference GUID”) associated with the transaction.

The methods and apparatus of the present invention may be embodied in the form of computer executable instructions (i.e., program code) stored on a computer-readable storage medium which instructions, when executed by a machine, such as a computer, perform and/or implement the methods and apparatus of the present invention. Specifically, any of the steps, operations or functions described above that are performed either at a merchant or the payment processor may be implemented in the form of such computer executable instructions. Computer readable storage media include both volatile and nonvolatile, removable and non-removable media implemented in any method or technology for storage of information. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by a computer.

As the foregoing illustrates, the present invention is directed to methods and systems that host account information by, for example, storing, processing, or transmitting account information at a payment processor to complete a transaction in such a manner that eliminates any need to host a customer account number at a point of sale location. It is understood that changes may be made to the embodiments described above without departing from the broad inventive concepts thereof. Accordingly, it is understood that the present invention is not limited to the particular embodiments disclosed, but is intended to cover all modifications that are within the spirit and scope of the invention as defined by the appended claims.

What is claimed:

1. A method of hosting account information at a payment processor for completing a transaction, the method comprising:
receiving from a point of sale of a merchant, an account number of a customer in response to initiation of the transaction at the point of sale, wherein the account number is received by the payment processor without being stored at the point of sale;
establishing a unique transaction identifier corresponding to the transaction, the unique transaction identifier also being associated with the account number;
storing the account number and the unique transaction identifier; and
providing the unique transaction identifier to the point of sale and the account number to an entity that provides payment to the merchant from an account associated with the account number of the customer to complete the sales transaction, whereby the transaction is completed without storing the account number of the customer at the point of sale.

2. The method of claim 1, wherein the merchant comprises one of the following: a retail merchant, an electronic commerce merchant, a mail order merchant, and a telephone order merchant.

3. The method of claim 1, wherein the point of sale provides a sales receipt to a customer to indicate that the sales transaction is complete, the sales receipt comprising the unique transaction identifier.

4. The method of claim 3, further comprising:
receiving the unique transaction identifier from the point of sale in connection with a request by the customer to void the transaction;
determining the account number associated with the unique transaction identifier;
using the account number to void the transaction; and
providing a confirmation to the point of sale indicative of the transaction being voided.

5. The method of claim 4, wherein the confirmation is provided to the customer via the point of sale to indicate the transaction being voided.

6. The method of claim 3 further comprising:
receiving the unique transaction identifier from the point of sale in connection with a request by the customer to receive a credit for the transaction;
determining the account number associated with the unique transaction identifier;
providing the account number to the entity;
receiving credit receipt information from the entity, wherein the credit receipt information indicates that credit has been applied to an account represented by the account number;
providing a credit receipt comprising unique the transaction identifier to the point of sale, wherein the credit receipt indicates the credit for the transaction corresponding to the unique transaction identifier.

7. The method of claim 6, wherein the credit receipt is provided to the customer via the point of sale to indicate the credit being completed for the transaction.

8. The method of claim 1, wherein the account number comprises one of the following: a savings account number, a credit card number, a debit card number, a loan account number, and a checking account number.

9. The method of claim 1, wherein the account number is received from the point of sale via a web page hosted by the payment processor.

10. The method of claim 9, wherein the web page emulates a terminal.

11. A method of hosting account information at a payment processor and for voiding a transaction, the method comprising:
receiving a unique transaction identifier from a point a sale of a merchant, the unique transaction identifier identifying the transaction;
determining an account number associated with the unique transaction identifier;
using the account number to void the transaction; and
providing a confirmation to the point of sale indicative of the transaction being voided.

12. The method of claim 11, wherein the confirmation is provided to a customer via the point of sale to indicate the transaction being voided.

13. The method of claim 11, wherein the point of the sale provides a sales receipt that includes the unique transaction identifier to a customer to indicate that the transaction is complete.

14. The method of claim 11, wherein the merchant comprises one of the following: a retail merchant, an electronic commerce merchant, a mail order merchant, and a telephone order merchant.

15. The method of claim 11, wherein the unique transaction identifier is received from the point of sale via a web page hosted by the payment processor.

16. A method of hosting account information at a payment processor and for crediting a transaction, the method comprising:
receiving a unique transaction identifier from a point of sale of a merchant;
determining an account number associated with the unique transaction identifier;
providing the account number to an entity that provides payment to the merchant from an account associated with the account number of a customer;
receiving credit receipt information from the entity, wherein the credit receipt information indicates a credit applied to an account identified by the account number;
providing a credit receipt comprising the unique transaction identifier to the point of sale, wherein the credit receipt indicates the credit for the transaction corresponding to the unique transaction identifier.

17. The method of claim 16, wherein the credit receipt is provided to a customer via the point of sale to indicate the credit being completed for the transaction.

18. The method of claim 16, wherein the point of sale provides a sales receipt that includes the unique transaction identifier to a customer to indicate that the transaction is complete.

19. The method of claim 16, wherein the merchant comprises one of the following: a retail merchant, an electronic commerce merchant, a mail order merchant, and a telephone order merchant.

20. The method of claim 16, wherein the unique transaction identifier is received from the point of sale via a web page hosted by the payment processor.
